(19) United States
(12) Patent Application Publication
(10) Pub. No.: US 2011/0259835 A1
(43) Pub. Date: Oct. 27, 2011

(54) Method for treating pool water containing high levels of isocyanuric acid and biological growth

(76) Inventor: David Hodak, Butler, PA (US)

(21) Appl. No.: 12/799,494

(22) Filed: Apr. 26, 2010

(51) Int. Cl. C02F 1/76; C02F 1/70

(52) U.S. Cl. 210/755; 210/757; 210/754

(57) ABSTRACT

A method for reducing an isocyanuric acid level concentration in swimming pool water to prevent chlorine lock. The method comprises the steps of adding an effective amount of sodium hydroxide combined with an antimicrobial agent to the pool water and reacting the sodium hydroxide with the isocyanuric acid therein to reduce the isocyanuric acid concentration to a level of between about 30 to 50 PPM. The antimicrobial agent reduces the amount of microorganisms that have accumulated in the pool water until the chlorine is released from its “locked-up” condition.

### CROSS-REFERENCE TO RELATED APPLICATIONS

None.

### STATEMENT REGARDING FEDERALLY SPONSORED RESEARCH OR DEVELOPMENT

None.

### NAMES OF THE PARTIES TO A JOINT RESEARCH AGREEMENT

None.

### BACKGROUND OF THE INVENTION

The invention is an improvement over that disclosed in U.S. Pat. No. 5,194,162. The invention of the '162 Patent related to a method of using sodium hydroxide to reduce the level of isocyanuric acid in swimming pool water. The problem with the '162 Patent was that it did not treat the biological growth that occurred as a result of ineffective chlorine. The present invention improves on the prior art by including a step in the method of treating swimming pool water that reduces the biological growth. This step treats the biological growth immediately, without the need to wait until the isocyanuric acid levels drop and the chlorine resumes its sanitizing duties.

The present invention relates generally to water treatment and, more particularly, to the chemical treatment of swimming pool water. In order to keep swimming pool water clear and free of unwanted biological growth, measured amounts of chlorine are commonly added to the pool water at given intervals. One common method of making chlorine additions is to add chlorine in the form of dry, granular calcium hypochlorite on a daily basis in a measured dose of, for example, 3-4 ounces per 5,000 gallons of contained pool water. In order to make the task of adding chlorine easier for the pool owner, and to extend the life of the chlorine, it is common to add an isocyanurate stabilizer to the pool water to prevent the usual rapid dissipation of chlorine which is caused by ultraviolet light degradation to thus permit less frequent chlorine additions. Chlorine has also been formulated into a slow-acting tablet form, commonly referred to as stabilized concentrated chlorinating tablets, which conveniently allows chlorine additions on a weekly basis.

While stabilized chlorinating tablets offer a significant convenience in the maintenance of pool water, they, likewise, possess an inherent shortcoming. Commonly used isocyanurate stabilizers form isocyanuric acid in the pool water. Isocyanuric acid is also known as cyanuric acid, triazine, and tricyanic acid, among other synonyms, and which is the isomer of fulminuric acid (2-cyano-2-nitroethanamide) represented by the chemical formula CNCN(NO₂)CONH₂. The isocyanuric acid stabilizers do not rapidly degrade and tend to accumulate in the pool water with the addition of more chlorine tablets.

It is observed that the isocyanuric acid concentration continues to increase in the pool water as additional isocyanurate stabilizers are added over a period of time. When the isocyanuric acid concentration in the pool water reaches a level of about 100 parts per million (PPM), a so-called “chlorine lock” occurs which renders further chlorine additions as ineffective, as the isocyanuric acid bonds to the chlorine. This condition is easily detected by way of a known pool water test wherein a conventional isocyanuric reagent turns progressively foggy within prescribed limits. Health departments and other regulators deem high levels of isocyanuric acid as unsafe due to the decreasing effectiveness of the chlorine, recommending levels not to exceed 50 ppm. Excessive isocyanuric acid levels allow bacteria, protozoa, algae, and other microorganisms to grow, due to the ineffectiveness of the “locked-up” chlorine, creating a health risk to swimmers.

When such a chlorine lock occurs, it is common practice to drain the saturated pool water and replace it with fresh water. This can be expensive and time consuming. Of course, continued isocyanurate stabilizer additions eventually cause a similar chlorine lock to occur in the replaced water, which requires yet another drain and replacement. Needless to say, this conventional practice of correcting the chlorine lock problem due to accumulated isocyanuric acid is not only inconvenient to the pool owner, requiring pool shut down, but also is expensive with respect to the high cost of replacement water which in a typical swimming pool may be on the order of about 30,000 gallons, for example.

Additionally, when pool owners see algae growing in their pool, or the presence of cloudy water, it is often their first instinct to add more chlorine. Unless the pool owner conducts a test for isocyanuric acid levels, they may assume that more chlorine is needed. Pool owners may add more chlorine even if they have added chlorine regularly as part of their maintenance schedule. The additional stabilized chlorine will only exacerbate the problem of excess cyanuric acid levels and will not improve the problematic water conditions. Similarly, even if a pool owner properly treats the excess isocyanuric acid problem (for example, by emptying the pool or by adding sodium hydroxide alone), they will have to add chlorine to treat any biological growth that occurred in the pool during the period which the chlorine was ineffective. The addition of chlorine could push the isocyanuric acid above target levels. Eventually, the pool owner can get stuck in a cycle of fluctuating isocyanuric acid levels.

### BRIEF SUMMARY OF THE INVENTION

My invention solves the problems heretofore encountered from the use of chlorine products having isocyanurate stabilizers by providing a method comprising the addition of a dry mixture or a solution containing an effective amount of sodium hydroxide combined with an effective amount of an antimicrobial agent to the saturated swimming pool water to cause a reaction whereby the excess isocyanuric acid is reduced to a level of below 100 PPM and the chlorine lock condition is relieved; additionally, buildup of biological growth, such as algae, is reduced, negating the need to immediately treat the pool water with additional chlorine. Preferably, the pool water is treated to yield a controlled isocyanuric acid concentration of between about 30-50 PPM. The addition of an antimicrobial agent to the sodium hydroxide solution allows the pool owner to more accurately treat the isocyanuric acid level since no additional stabilizers (as part of an addition of stabilized chlorine) will be added. By decreasing both the isocyanuric acid level and the amount of biological growth, the pool owner can resume normal maintenance of the pool with stabilized chlorine, thereby precluding a cycle of fluctuating isocyanuric acid levels.

### DETAILED DESCRIPTION OF THE INVENTION

In order to treat swimming pool water which has accumulated isocyanuric acid therein as a result of repeated use of stabilized chlorinating tablets or other isocyanurate based stabilizer additions, the inventor contemplates the addition of an effective amount of sodium hydroxide (NaOH) combined with an antimicrobial agent to the pool water. Alkyl dimethylbenzyl ammonium chloride is a preferred antimicrobial agent. The sodium hydroxide reacts with the excess isocyanuric acid in the pool water so as to reduce the concentration of isocyanuric acid to a level below 100 PPM and preferably to a concentration of between about 30-50 PPM. The sodium hydroxide may be added in dry form or as a prepared liquid solution. The antimicrobial agent, as part of the solution, kills many of the microorganisms that have accumulated in the pool water during the period in which the chlorine was ineffective due to excessive isocyanuric acid levels. The use of an antimicrobial agent immediately reduces biological growth in the pool since the chlorine is “locked up” with the isocyanuric acid and will require a longer period of time to effectively sanitize the water. Additionally, the antimicrobial agent is one-time use fix for the additional biological growth, unlike chlorine, which must be maintained at a fixed concentration in the pool water to prevent biological growth.

By way of illustration, a preferred sodium hydroxide solution is prepared by mixing reagent grade or commercial grade sodium hydroxide with water to form an aqueous solution of between 5%-10% (by weight) of a sodium hydroxide. Preferably, one-half gallon of the 5% sodium hydroxide/water solution is used to treat 10,000 gallons of pool water containing in excess of 100 PPM of isocyanuric acid. Thus, in order to treat a typical pool, for example, containing 30,000 gallons of water, one and one-half gallons of the 5% sodium hydroxide solution is usually effective in reducing the excess isocyanuric acid to a preferred, controlled level of between about 30-50 PPM in the treated pool water. At that reduced concentration, the isocyanuric acid no longer causes the so-called chlorine lock and the conventional treatment methods utilizing stabilized chlorinating tablets or the like may be continued.

In the preferred embodiment contemplated by the inventor, alkyl dimethylbenzyl ammonium chloride is used as an antimicrobial agent. Typically, six liquid ounces of a 50% solution of alkyl dimethylbenzyl ammonium chloride is added per 10,000 gallons of pool water to initially treat a pool showing signs of algae growth, or growth of other organisms. One skilled in the art will appreciate the amount of the antimicrobial agent added to the solution will vary depending on the concentration of alkyl dimethylbenzyl ammonium chloride used. In the present invention, the solution of sodium hydroxide and the antimicrobial agent contains about three liquid ounces of pure alkyl dimethylbenzyl ammonium chloride.

While specific embodiments of the invention have been described in detail, it will be appreciated by those skilled in the art that various modifications and alternatives to those details could be developed in light of the overall teachings of the disclosure. The presently preferred embodiments described herein are meant to be illustrative only and not limiting as to the scope of the invention which is to be given the full breadth of the appended claims and any and all equivalents thereof.

What I claim is:

1. A method for treating swimming pool water containing an excess concentration of isocyanuric acid therein, the method comprising the steps of adding an effective amount of sodium hydroxide combined with an effective amount of an antimicrobial agent to the pool water and reacting the sodium hydroxide with the isocyanuric acid to thereby reduce the isocyanuric acid to a desired concentration and killing microorganisms in the pool water.

2. The method of claim 1 wherein sodium hydroxide combined with an antimicrobial agent is added to the pool water in the form of a solution of sodium hydroxide and an antimicrobial agent.

3. The method of claim 1 wherein the desired reduced concentration of isocyanuric acid is between about 30-50 PPM.

4. The method of claim 1 wherein the concentration of isocyanuric acid is reduced and biological growth is reduced without adding additional chlorine.

5. The method of claim 1 wherein the antimicrobial agent is alkyl dimethylbenzyl ammonium chloride.

6. The method of claim 2 wherein the solution contains between about 5%-10% by weight sodium hydroxide in water.

7. The method of claim 2 wherein the solution contains about 5% by weight sodium hydroxide and about ½ gallon of said solution is added per 10,000 gallons of pool water to be treated.

8. The method of claim 2 wherein the solution contains about 3 liquid ounces of alkyl dimethylbenzyl ammonium chloride and is added per 10,000 gallons of pool water to be treated.

9. A method for treating swimming pool water containing a concentration of isocyanuric acid in excess of 100 PPM, the method comprising the steps of adding an aqueous solution containing about 5% by weight sodium hydroxide and 3 liquid ounces of alkyl dimethylbenzyl ammonium chloride to the pool water in an amount of about ½ gallon of said solution per 10,000 gallons of pool water;
reacting the sodium hydroxide with the isocyanuric acid;
reducing the isocyanuric acid in said pool water to a concentration of between about 30 to about 50 PPM; and
reducing the amount microorganisms present in said pool water.
